(19) United States
(12) Patent Application Publication
(10) Pub. No.: US 2012/0044271 A1
(43) Pub. Date: Feb. 23, 2012

(54) ACTIVE MATRIX ORGANIC LIGHT EMITTING DIODE DISPLAY HAVING DETERIORATION DETECTION FUNCTION IN PROGRAMMING PERIOD

(75) Inventors: Yeun Joong LEE, Seoul (KR); Sang Hyun CHA, Seoul (KR); Gyu Hyeong CHO, Daejeon (KR); Jin Yong JEON, Daegu (KR); Jun Hyeok YANG, Daegu (KR); Hyun Sik KIM, Jeonju (KR); Jae Shin LEE, Anyang (KR)

(73) Assignees: KOREA ADVANCED INSTITUTE OF SCIENCE AND TECHNOLOGY, Daejeon (KR); SAMSUNG ELECTRO-MECHANICS CO., LTD., Gyunggi-do (KR)

(21) Appl. No.: 13/115,403

(22) Filed: May 25, 2011

(30) Foreign Application Priority Data
Aug. 19, 2010 (KR) 10-2010-0080517

(51) Int. Cl. G09G 3/32; G09G 5/10

(52) U.S. Cl. 345/690; 345/77

(57) ABSTRACT

There is provided an active matrix organic light emitting diode display including: a data driving unit converting previously prepared correction data into a correction signal and generates a driving signal according to the analog correction signal; a pixel unit having an organic light emitting diode (OLED) between first and second power supply terminals receiving first and second powers, respectively, charging a value corresponding to the correction data according to the driving signal in a predetermined programming period, detecting the driving signal in order to detect deterioration, and allowing current to flow through the OLED according to the value charged in the predetermined programming period in a predetermined holding period; and an ADC detecting deterioration voltage corresponding to the driving signal having deterioration information of the OLED of the pixel unit in the holding period.

### CROSS-REFERENCE TO RELATED APPLICATIONS

This application claims the priority of Korean Patent Application No. 10-2010-0080517 filed on Aug. 19, 2010, in the Korean Intellectual Property Office, the disclosure of which is incorporated herein by reference.

### BACKGROUND OF THE INVENTION

1. Field of the Invention

The present invention relates to an active matrix organic light emitting diode (AMOLED) display which can be applied to a display system, and more particularly, to an AMOLED display which can rapidly detect deterioration by performing deterioration detection in a programming period to thereby perform deterioration compensation rapidly.

2. Description of the Related Art

In general, in order to manufacture a large-sized display panel by using an organic light emitting diode (OLED), prominent as a next-generation display device, the OLED display is configured to have an active matrix structure, which is referred to as an active matrix OLED display (a so called ‘AMOLED’ display).

Since such an AMOLED display does not require an additional light source, the AMOLED display shows outstanding performance in terms of brightness, thickness, definition, speed, and power consumption as compared with an LCD panel using a backlight unit (BLU) as an additional light source.

However, the AMOLED display has disadvantages in that uniformity between pixels and uniformity according to time are very low, and a circuit for compensating for uniformity is required.

In general, an AMOLED driving method includes a current driving method and a voltage driving method. The voltage driving method of the AMOLED display has a disadvantage in that an output varies due to deterioration of mobility or threshold voltage of a transistor.

In order to solve the disadvantages of the AMOLED due to the deterioration of the threshold voltage, a compensation circuit for compensating for the deterioration is required. In addition, in the voltage driving method of the AMOLED display, since a period, in which a deterioration level is detected, is additionally required, excessive time may be required to detect and compensate for deterioration.

### SUMMARY OF THE INVENTION

An aspect of the present invention provides an active matrix organic light emitting diode (AMOLED) display which can rapidly detect deterioration by performing deterioration detection in a programming period to thereby perform deterioration compensation rapidly.

According to an aspect of the present invention, there is provided an active matrix organic light emitting diode display including: a data driving unit converting previously prepared correction data into an analog correction signal and generating a driving signal according to the analog correction signal; a pixel unit having an organic light emitting diode connected between first and second power supply terminals receiving first and second powers, respectively, charging a value corresponding to the correction data according to the driving signal in a predetermined programming period, detecting the driving signal in order to detect deterioration, and allowing current to flow through the organic light emitting diode according to the value charged in the predetermined programming period in a predetermined holding period; andan analog-to-digital converter (ADC) detecting the driving signal having deterioration information of the organic light emitting diode of the pixel unit as deterioration voltage in the programming period.

The pixel unit may further include first and second MOS transistors connected in series between the first power supply terminal receiving the first power and the organic light emitting diode; a third MOS transistor connected between a first connection node, connected between the first and second MOS transistors, and the data driving unit; a charging capacitor connected between a gate of the second MOS transistor and the first connection node; and a fourth MOS transistor having a drain connected to a drain of the second MOS transistor and a source connected to the gate of the second MOS transistor.

The pixel unit may be configured such that the second, third, and fourth MOS transistors are turned on and the first MOS transistor is turned off in the programming period, and the first and second MOS transistors are turned on and the third and fourth MOS transistors are turned off in the holding period.

The pixel unit may allow the driving signal of the data driving unit to pass through the second and third MOS transistors and flow through the organic light emitting diode in the programming period and store the value corresponding to the correction data in the charging capacitor. The pixel unit may allow the current to flow from the first power supply terminal to the organic light emitting diode through the first and second MOS transistors according to the value stored in the charging capacitor in the holding period.

The ADC may detect the deterioration voltage having the deterioration information of the organic light emitting diode in an input node of the pixel unit, into which the driving signal of the data driving unit is inputted, in the programming period.

The active matrix organic light emitting diode display may further include a compensation unit generating a deterioration compensation signal for deterioration compensation by using digital deterioration voltage from the ADC; and a converting unit converting input data into correction data, in which deterioration is compensated for, by using the deterioration compensation signal and providing the converted correction data to the data driving unit.

According to another aspect of the present invention, there is provided an active matrix organic light emitting diode display including: a data driving unit converting previously prepared correction data into an analog correction signal and generating a driving signal according to the analog correction signal; a pixel unit having an organic light emitting diode connected between first and second power supply terminals receiving first and second powers, respectively, charging a value corresponding to the correction data according to the driving signal in a predetermined programming period, detecting the driving signal in order to detect deterioration, and allowing current to flow through the organic light emitting diode according to the value charged in the predetermined programming period in a predetermined holding period; an analog-to-digital converter (ADC) detecting deterioration voltage having deterioration information of the organic light emitting diode of the pixel unit and converting the detected deterioration voltage into digital deterioration voltage in the holding period; a compensation unit generating a deterioration compensation signal for deterioration compensation by using the digital deterioration voltage from the ADC; and a converting unit converting input data into correction data, in which deterioration is compensated for, by using the deterioration compensation signal and providing the correction data to the data driving unit.

The pixel unit may further include first and second MOS transistors connected in series between the first power supply terminal receiving the first power and the organic light emitting diode; a third MOS transistor connected between a first connection node, connected between the first and second MOS transistors, and the data driving unit; a charging capacitor connected between a gate of the second MOS transistor and the first connection node; and a fourth MOS transistor having a drain connected to a drain of the second MOS transistor and a source connected to the gate of the second MOS transistor.

The pixel unit may be configured such that the second, third, and fourth MOS transistors are turned on and the first MOS transistor is turned off in the programming period, and the first and second MOS transistors are turned on and the third and fourth MOS transistors are turned off in the holding period.

The pixel unit may allow the driving signal of the data driving unit to pass through the second and third MOS transistors and flow through the organic light emitting diode in the programming period and may store the value corresponding to the correction data in the charging capacitor. The pixel unit may allow the current to flow from the first power supply terminal to the organic light emitting diode through the first and second MOS transistors according to the value stored in the charging capacitor in the holding period.

The ADC may detect the deterioration voltage having the deterioration information of the organic light emitting diode in an input node of the pixel unit, into which the driving signal of the data driving unit is inputted, and convert the detected deterioration voltage into the digital deterioration voltage in the programming period.

### BRIEF DESCRIPTION OF THE DRAWINGS

The above and other aspects, features and other advantages of the present invention will be more clearly understood from the following detailed description taken in conjunction with the accompanying drawings, in which:

FIG. 1 is a block diagram of an active matrix organic light emitting diode (AMOLED) display according to an exemplary embodiment of the present invention;

FIG. 2 is a flowchart illustrating the operation of an AMOLED display according to an exemplary embodiment of the present invention;

FIG. 3 is a time chart of an AMOLED display according to an exemplary embodiment of the present invention;

FIG. 4 is a diagram illustrating the operation of an AMOLED display in a programming period according to an exemplary embodiment of the present invention; and

FIG. 5 is a diagram illustrating the operation of an AMOLED display in a holding period according to an exemplary embodiment of the present invention.

### DETAILED DESCRIPTION OF THE PREFERRED EMBODIMENT

Exemplary embodiments of the present invention will now be described in detail with reference to the accompanying drawings.

The present invention is not limited to the exemplary embodiments and the exemplary embodiments are merely used to help in understanding the spirit of the present invention. Like reference numerals refer to like elements in the accompanying drawings.

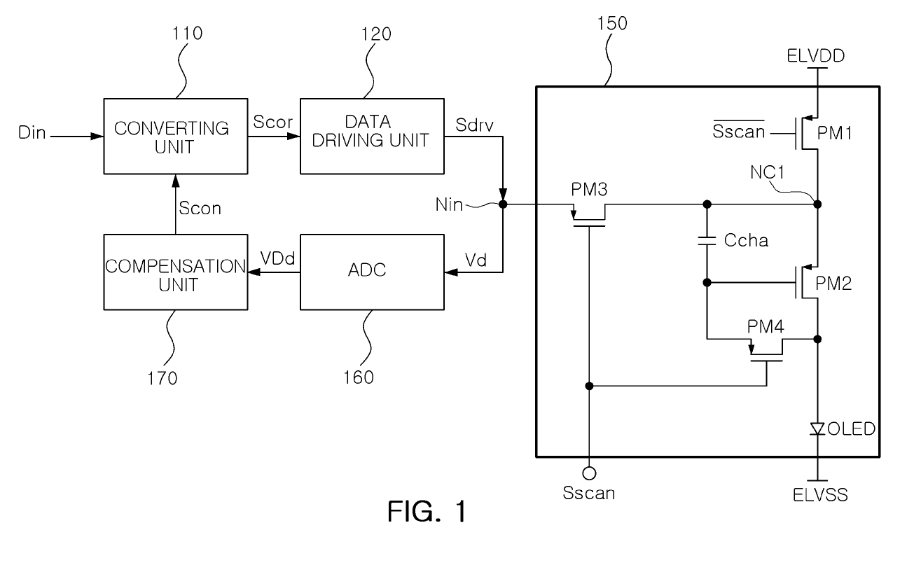

FIG. 1 is a block diagram of an active matrix organic light emitting diode (AMOLED) display according to an exemplary embodiment of the present invention.

Referring to FIG. 1, an AMOLED display according to an exemplary embodiment of the present invention may include a data driving unit 120 that converts previously prepared correction data into an analog correction signal Scor and generates a driving signal according to the analog correction signal Scor.

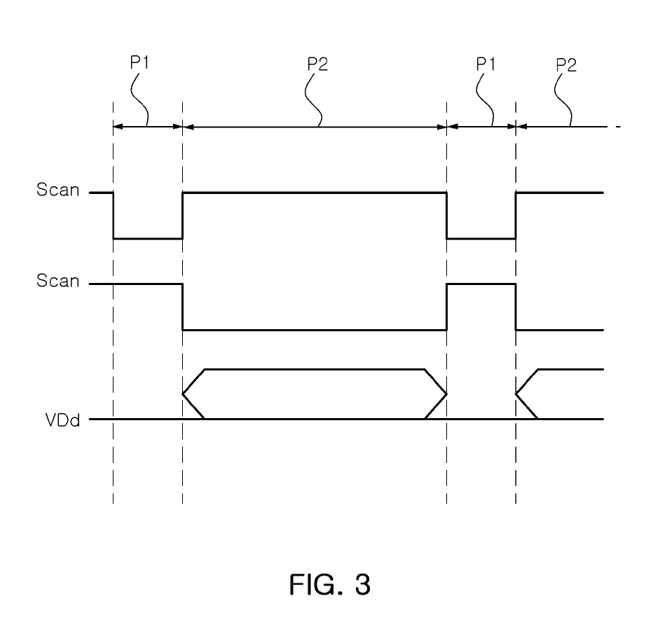

Further, the AMOLED display according to the embodiment of the present invention may include a pixel unit 150 that has an organic light emitting diode (OLED) connected between first and second power supply terminals EVLDD and ELVSS receiving first and second powers, charges a value corresponding to the correction data according to the driving signal in a programming period (P1 of FIG. 3), detects the driving signal in order to detect deterioration, and allows current to flow through the OLED according to the value charged in the predetermined programming period in a holding period (P2 of FIG. 3).

The AMOLED display according to the embodiment of the present invention may include an analog-to-digital converter (ADC) 160 that detects deterioration voltage Vd corresponding to a driving signal having deterioration information of the OLED of the pixel unit 150 and converts the detected deterioration voltage into digital deterioration voltage VDd.

The pixel unit 150 may further include first and second MOS transistors PM1 and PM2 connected in series between the power supply terminal ELVDD receiving the first power and the OLED, a third MOS transistor PM3 connected between a first connection node NC1, connected between the first and second MOS transistors, and the data driving unit 120, a charging capacitor Ccha connected between a gate of the second MOS transistor PM2 and the first connection node NC1, and a fourth MOS transistor PM4 having a drain connected to a drain of the second MOS transistor PM2 and a source connected to the gate of the second MOS transistor PM2.

The pixel unit 150 may be configured such that the second, third and fourth MOS transistors PM2, PM3 and PM4 are turned on and the first MOS transistor PM1 is turned off in the programming period P1, and the first and second MOS transistors PM1 and PM2 are turned on and the third and fourth MOS transistors PM3 and PM4 are turned off in the holding period P2.

Further, the pixel unit 150 may be configured in the programming period P1 such that the driving signal passes through the second and third MOS transistors PM2 and PM3 and flows through the OLED, and the value corresponding to the correction data is stored in the charging capacitor Ccha .

In addition, the pixel unit 150 may be configured in the holding period P2 such that current from the first power supply terminal ELVDD passes through the first and second MOS transistors PM1 and PM2 and the OLED and flows to the second power supply terminal ELVSS according to the value stored in the charging capacitor Ccha.

The ADC 160 may be configured to detect the deterioration voltage having the deterioration information of the OLED in an input node Nin of the pixel unit 150, into which the driving signal of the data driving unit 120 is inputted, in the programming period P1.

Further, the AMOLED display according to the embodiment of the present invention may further include a compensation unit 170 generating a deterioration compensation signal Scon for deterioration compensation by using digital deterioration voltage VDd from the ADC 160, and a converting unit 110 converting input data Din into correction data, in which deterioration is compensated for, by using the deterioration compensation signal Scon and providing the converted correction data to the data driving unit 120.

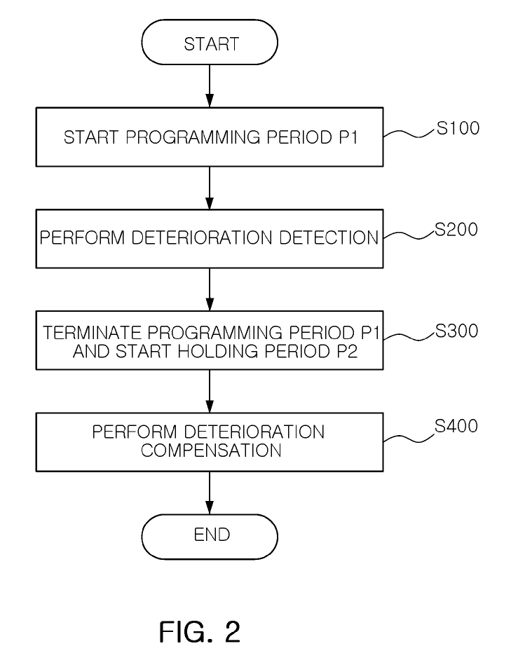

FIG. 2 is a flowchart of an AMOLED display according to an exemplary embodiment of the present invention. In FIG.

2, the programming period P1 starts in operation S100. A deterioration detecting operation is performed in operation S200. The programming period P1 terminates and the holding period P2 starts in operation S300. In addition, deterioration compensation is performed on the basis of the deterioration detection in the holding period P2 in operation S400.

FIG. 3 is a time chart of an AMOLED display according to the embodiment of the present invention. In FIG. 3, P1 represents the programming period; P2 represents the holding period; Sscan represents a gate signal applied to a gate of the third MOS transistor PM3 of the pixel unit 150; and Sscan represents an inversion signal of Sscan supplied to a gate of the first MOS transistor PM1. In addition, VDd is the digital deterioration voltage outputted from the ADC 160.

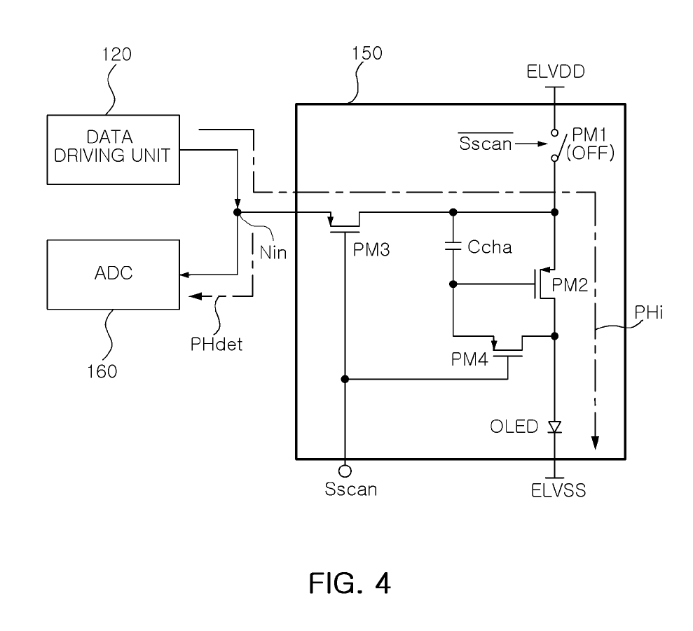

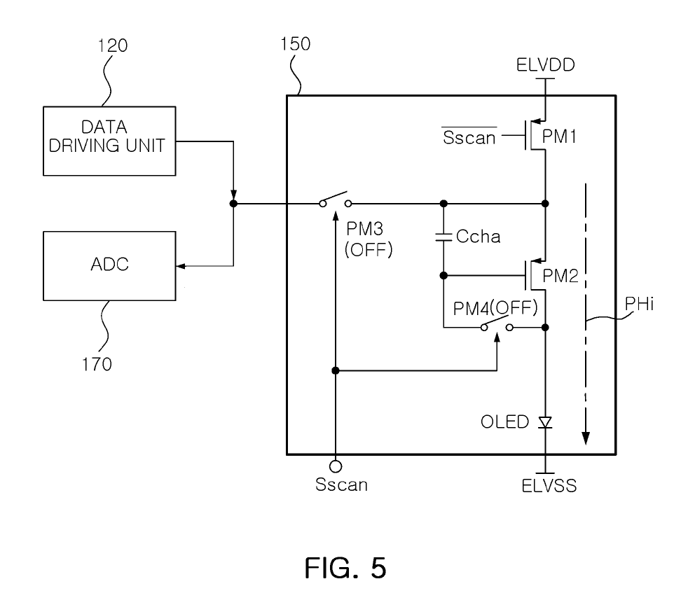

FIG. 4 is a diagram illustrating the operation of an AMOLED display in a programming period according to an exemplary embodiment of the present invention, and FIG. 5 is a diagram illustrating the operation of an AMOLED display in a holding period according to an exemplary embodiment of the present invention.

In FIG. 4, PHi represents a current path in the programming period P1 and PHdet represents a deterioration detection path in the AMOLED display according to the embodiment of the present invention. In FIG. 5, PHi represents a current path in the holding period P2 in the AMOLED display according to the embodiment of the present invention.

Hereinafter, operations and effects of the present invention will be described with reference to the accompanying drawings.

Referring to FIGS. 1 to 5, an AMOLED display according to an exemplary embodiment of the present invention will be described for each of the predetermined programming period P1 and holding period P2.

First, the operation of the AMOLED display in the programming period P1 will be described.

Referring to FIG. 1, the data driving unit 120 starts the operation corresponding to the programming period P1, to convert the previously prepared correction data into the analog correction signal Scor, and generate and supplies the driving signal to the pixel unit 150 according to the analog correction signal Scor as shown in FIG. 2 (S100 of FIG. 2).

At this time, in the pixel unit 150, a value corresponding to the correction data may be charged according to the driving signal in the programming period P1.

That is, in the pixel unit 150, the second, third and fourth MOS transistors PM2, PM3 and PM4 are turned on and the first MOS transistor PM1 is turned off in the programming period P1.

As a result, the pixel unit 150 may allow the driving signal to pass through the second and third MOS transistors PM2 and PM3 and flow through the OLED in the programming period P1, and thus the value corresponding to the correction data is stored in the charging capacitor Ccha as shown in FIG. 4.

Simultaneously, the ADC 160 may detect the deterioration voltage having the deterioration information of the OLED in the input node Nin of the pixel unit 150, into which the driving signal of the data driving unit 120 is inputted, in the programming period P1 as shown in FIGS. 2 and 3.

Subsequently, the compensation unit 170 of the present invention may generate the deterioration compensation signal Scon for deterioration compensation by using the digital deterioration voltage VDd from the ADC 160 and provide the deterioration compensation signal Scon to the converting unit 110.

At this time, the converting unit 110 may convert the input data Din into the correction data, in which deterioration is compensated for, and provide the corresponding correction data to the data driving unit 120.

As a result, as described above, the data driving unit 120 may convert the correction data into the analog correction signal Scor and generate the driving signal according to the analog correction signal Scor.

Hereinafter, the operation of the AMOLED display in the holding period P2 will be described.

Referring to FIG. 1, in the pixel unit 150 of the present invention, current flows through the OLED according to the value charged in the predetermined programming period in the holding period P2.

That is, in the pixel unit 150, the first and second MOS transistors PM1 and PM2 are turned on and the third and fourth MOS transistors PM3 and PM4 are turned off in the holding period P2.

As a result, the pixel unit 150 may allow the current to flow from the first power supply terminal to the OLED through the first and second MOS transistors PM1 and PM2 according to the value stored in the charging capacitor Ccha in the holding period P2.

As described above, compensation for deteriorations in terms of aging, temperature, and process can be performed without being affected by deteriorations in terms of mobility and threshold voltage of the transistors.

Further, an influence of the deterioration in terms of mobility and threshold voltage of the transistors with respect to the current used to drive the OLED by using the compensation current driving method may be removed. In addition, since deterioration is detected in the programming period, without an additional period to detect the deterioration level of the OLED, deterioration compensation can be performed while displaying.

As set forth above, an AMOLED display according to exemplary embodiments of the invention can rapidly detect deterioration by performing deterioration detection in a programming period to thereby perform deterioration compensation rapidly.

While the present invention has been shown and described in connection with the exemplary embodiments, it will be apparent to those skilled in the art that modifications and variations can be made without departing from the spirit and scope of the invention as defined by the appended claims.

What is claimed is:

1. An active matrix organic light emitting diode display comprising:
a data driving unit converting previously prepared correction data into an analog correction signal and generating a driving signal according to the analog correction signal;
a pixel unit having an organic light emitting diode connected between first and second power supply terminals receiving first and second powers, respectively, charging a value corresponding to the correction data according to the driving signal in a predetermined programming period, detecting the driving signal in order to detect deterioration, and allowing current to flow through the organic light emitting diode according to the value charged in the predetermined programming period in a predetermined holding period; and
an analog-to-digital converter (ADC) detecting the driving signal having deterioration information of the organic light emitting diode of the pixel unit as deterioration voltage in the programming period.

2. The active matrix organic light emitting diode display of claim 1, wherein the pixel unit further comprises:
first and second MOS transistors connected in series between the first power supply terminal receiving the first power and the organic light emitting diode;
a third MOS transistor connected between a first connection node, connected between the first and second MOS transistors, and the data driving unit;
a charging capacitor connected between a gate of the second MOS transistor and the first connection node; and
a fourth MOS transistor having a drain connected to a drain of the second MOS transistor and a source connected to the gate of the second MOS transistor.

3. The active matrix organic light emitting diode display of claim 2, wherein the pixel unit is configured such that the second, third, and fourth MOS transistors are turned on and the first MOS transistor is turned off in the programming period, and the first and second MOS transistors are turned on and the third and fourth MOS transistors are turned off in the holding period.

4. The active matrix organic light emitting diode display of claim 3, wherein the pixel unit allows the driving signal of the data driving unit to pass through the second and third MOS transistors and flow through the organic light emitting diode in the programming period and stores the value corresponding to the correction data in the charging capacitor, and
the pixel unit allows the current to flow from the first power supply terminal to the organic light emitting diode through the first and second MOS transistors according to the value stored in the charging capacitor in the holding period.

5. The active matrix organic light emitting diode display of claim 4, wherein the ADC detects the deterioration voltage having the deterioration information of the organic light emitting diode in an input node of the pixel unit, into which the driving signal of the data driving unit is inputted, in the programming period.

6. The active matrix organic light emitting diode display of claim 5, further comprising:
a compensation unit generating a deterioration compensation signal for deterioration compensation by using digital deterioration voltage from the ADC; and
a converting unit converting input data into correction data, in which deterioration is compensated for, by using the deterioration compensation signal and providing the converted correction data to the data driving unit.

7. An active matrix organic light emitting diode display comprising:
a data driving unit converting previously prepared correction data into an analog correction signal and generating a driving signal according to the analog correction signal;
a pixel unit having an organic light emitting diode connected between first and second power supply terminals receiving first and second powers, respectively, charging a value corresponding to the correction data according to the driving signal in a predetermined programming period, detecting the driving signal in order to detect deterioration, and allowing current to flow through the organic light emitting diode according to the value charged in the predetermined programming period in a predetermined holding period;
an analog-to-digital converter (ADC) detecting deterioration voltage having deterioration information of the organic light emitting diode of the pixel unit and converting the detected deterioration voltage into digital deterioration voltage in the holding period;
a compensation unit generating a deterioration compensation signal for deterioration compensation by using the digital deterioration voltage from the ADC; and
a converting unit converting input data into correction data, in which deterioration is compensated for, by using the deterioration compensation signal and providing the correction data to the data driving unit.

8. The active matrix organic light emitting diode display of claim 7, wherein the pixel unit further comprises:
first and second MOS transistors connected in series between the first power supply terminal receiving the first power and the organic light emitting diode;
a third MOS transistor connected between a first connection node, connected between the first and second MOS transistors, and the data driving unit;
a charging capacitor connected between a gate of the second MOS transistor and the first connection node; and
a fourth MOS transistor having a drain connected to a drain of the second MOS transistor and a source connected to the gate of the second MOS transistor.

9. The active matrix organic light emitting diode display of claim 8, wherein the pixel unit is configured such that the second, third, and fourth MOS transistors are turned on and the first MOS transistor is turned off in the programming period, and the first and second MOS transistors are turned on and the third and fourth MOS transistors are turned off in the holding period.

10. The active matrix organic light emitting diode display of claim 9, wherein the pixel unit allows the driving signal of the data driving unit to pass through the second and third MOS transistors and flow through the organic light emitting diode in the programming period and stores the value corresponding to the correction data in the charging capacitor, and
the pixel unit allows the current to flow from the first power supply terminal to the organic light emitting diode through the first and second MOS transistors according to the value stored in the charging capacitor in the holding period.

11. The active matrix organic light emitting diode display of claim 10, wherein the ADC detects the deterioration voltage having the deterioration information of the organic light emitting diode in an input node of the pixel unit, into which the driving signal of the data driving unit is inputted, and converts the detected deterioration voltage into the digital deterioration voltage in the programming period.
